(19) United States
(12) Patent Application Publication
(10) Pub. No.: US 2007/0287576 A1
(43) Pub. Date: Dec. 13, 2007

(54) Device For Power Transmission In A Vehicle Between A Heat Engine Shaft And A Wheel Shaft

(75) Inventors: Geraud Leneneu, Rueil-Malmaison (FR); Jacques Laeuffer, Paris (FR); Sebastein Besnard, Sceaux (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/575,946

(22) PCT Filed: Sep. 20, 2005
(86) PCT No.: PCT/FR05/50766

§ 371 Date: Mar. 23, 2007

(30) Foreign Application Priority Data
Sep. 24, 2004 (FR) 0452160

(51) Int. Cl. F16H 3/44

(52) U.S. Cl. 475/332; 903/915

(57) ABSTRACT

The invention concerns a device for power transmission, in a vehicle, between a heat engine shaft and a wheel shaft (5). The invention concerns essentially a device (1) for power transmission between a shaft (2) of a heat engine (3) and a shaft (4) of wheels (5). A mechanical assembly (10) mutually connects the shaft (4) of wheels (5), the shaft (2) of the engine (3) and the shafts (8, 9) of two electrical machines (6, 7). This mechanical assembly (10) comprises at least two mutually connected planetary gearsets (49, 50). The invention is characterized in that the two planetary gearsets (49, 50) have a common planet pinion cage (57) and mutually meshing planet pinions (53-56). In another embodiment, the planet pinions (53, 56) of the two gearsets (49, 50) are mutually integral and coaxial.

The present invention concerns a device for power transmission between a heat engine shaft and a wheel shaft of a vehicle. In particular, a purpose of the invention is to limit the number of parts used in such a device. The present invention has particularly useful applications in motor vehicles, but it could also be used in trains, boats or motorcycles.

Devices for power transmission between a heat engine shaft and a wheel shaft are known in hybrid vehicles. Devices of this kind are described in application FR-A-2832357. These transmission devices generally include a heat engine and a pair of electric machines. The engine shaft, the wheel shaft and the machine shafts are connected to one another through a mechanical assembly. The two machines are connected to one another via a linking device that includes in particular an electrical bus. These machines function as a motor or as a generator, depending on the electrical and mechanical forces applied to their shafts and their terminals, respectively.

Power supplied by the heat engine can be either transmitted directly to the wheel shaft through the mechanical assembly or diverted into an electrical system that includes the electric machines and the linking device. The power diverted to the electrical system is transmitted to the wheel shaft in such a way as to adjust the torque applied to this shaft, while also adjusting the torque and speed of the heat engine to an operating point that minimizes the consumption of this engine.

The transmission device may or may not include a storage device, such as a battery, connected to the electrical bus. When the transmission device does not have a battery, derived power is transmitted directly to the mechanical assembly. Such an embodiment of the transmission device makes it possible to lower the overall cost of the transmission device, since batteries are expensive.

When the transmission device includes a storage device connected to the electrical bus, some or all of the derived power can be stored in the storage device. The storage device allows the transmission device to have a greater number of performance regimes. For example, in a specific power boost mode, the two machines operate simultaneously as a motor. And in battery recharge mode, the two machines can operate simultaneously as a generator in order to store the maximum amount of energy.

In the existing embodiments, the mechanical assembly is usually made up of one or more planetary gear trains. A planetary gear train is defined as a mechanism made up of gear assemblies, including a pinion or group of pinions called planets, the axis of which rotates on the same axis as the other pinions, called a ring gear and a sun gear. These planet gears are carried by a planet carrier. Each planetary gear train usually has a sun gear, a planet carrier and a ring gear. Each gear train therefore has three degrees of freedom of rotation.

In the mechanical assembly of the transmission device, the planetary gear trains are interconnected in such a way so as to offer four degrees of freedom: one for the engine shaft, another for the wheel shaft, and two others for the shafts of the two electric machines. In one particular embodiment, the transmission device has two planetary gear trains. These two gear trains have two connections linking them to one another in order to reduce their six possible degrees of freedom to four. In one example, the sun gear on the first gear train is connected to a ring gear on the second gear train, and the planet carriers of the two gear trains are connected to one another.

However, these gear train assemblies make the transmission device cumbersome. By connecting a sun gear to a ring gear, one of the useful elements of the mechanical assembly loses its mobility. A useful element is defined as an element to which one of the shafts of the device is connectable. Furthermore, increasing the number of linkages between the different elements of the different gear trains increases the risk of mechanical failure.

A purpose of the present invention is thus to reduce the number of parts used in the mechanical assembly in order to make the assembly more compact without losing the mobility of one of its useful elements.

To this end, in the transmission device according to the invention, the two gear trains are connected so that they share a common planet carrier and their planet gears are interconnected.

The fact that the planet carrier is shared makes it possible to avoid the need for a connection between two planet carriers on two gear trains, for example. The fact that the planet gears are intermeshing eliminates one element of the mechanical assembly.

More precisely, connecting the planet gears is a way to retain the greatest number of degrees of freedom in the mechanical assembly, as they are not useful elements, since they are not meant to be connected to any of the shafts of the device. Thus, with two planetary gear trains interconnected in the manner of the invention, one has five degrees of freedom available. This makes it possible to eliminate one of the elements of the two gear trains, such as the ring gear of one of the trains, in order to obtain the four degrees of freedom needed for the smooth operation of the transmission device. By eliminating one of these elements, it is clear that the mechanical assembly of the device according to the invention can be made more compact.

In a first embodiment of the invention, the planet gears of the gear trains mesh with one another. Such a gear train assembly may take the form of a Ravigneaux-type gear train.

In a second embodiment, the planets of the gear trains of the mechanical assembly are stepped planet gears. Planet gears are said to be stepped when they are integral with one another and coaxial.

The transmission device according to the invention has several different operating modes. In each operating mode, a shaft of one of the machines is connected to a different element of one of the gear trains.

For example, an assembly of two gear trains produces five degrees of freedom, as previously mentioned, when all of the elements of both gear trains are retained. One degree of freedom is used for the shaft of the heat engine, and another degree of freedom is used for the shaft of wheels. The other three degrees of freedom allow the device to run in three different operating modes.

When a new gear train is introduced into the mechanical assembly according to the invention, this introduces two new mobile elements to which the shafts of the machines are connectable. Two new possible operating modes for the transmission device can thus be introduced.

The present invention concerns a device for power transmission in a vehicle between a shaft of a heat engine and a shaft of wheels, including

a first and a second electric machine, and

a mechanical assembly connecting the shaft of the engine, the shaft of wheels and shafts of the two electric machines to one another, this mechanical assembly having at least two interconnected planetary gear trains, these two planetary gear trains each having several intermeshing elements, including a ring gear, planet gears connected to a planet carrier, and a sun gear,

characterized in that

the two planetary gear trains share a common planet carrier that drives shafts in contact with the shared planet carrier and the planet gears.

The following description and accompanying figures will make the invention more easily understood. These figures are given as a guide, and are in no way an exhaustive representation of the invention. The figures show:

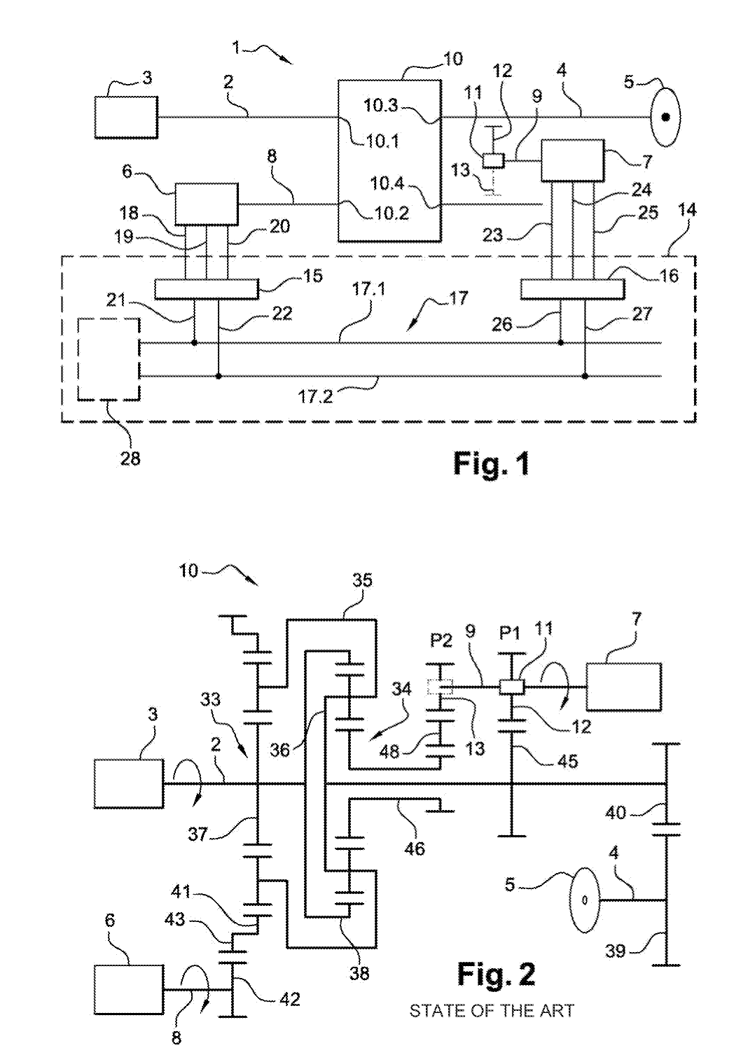

FIG. 1: A general schematic representation of a transmission device having two operating modes;

FIG. 2: A schematic representation of a prior art transmission device;

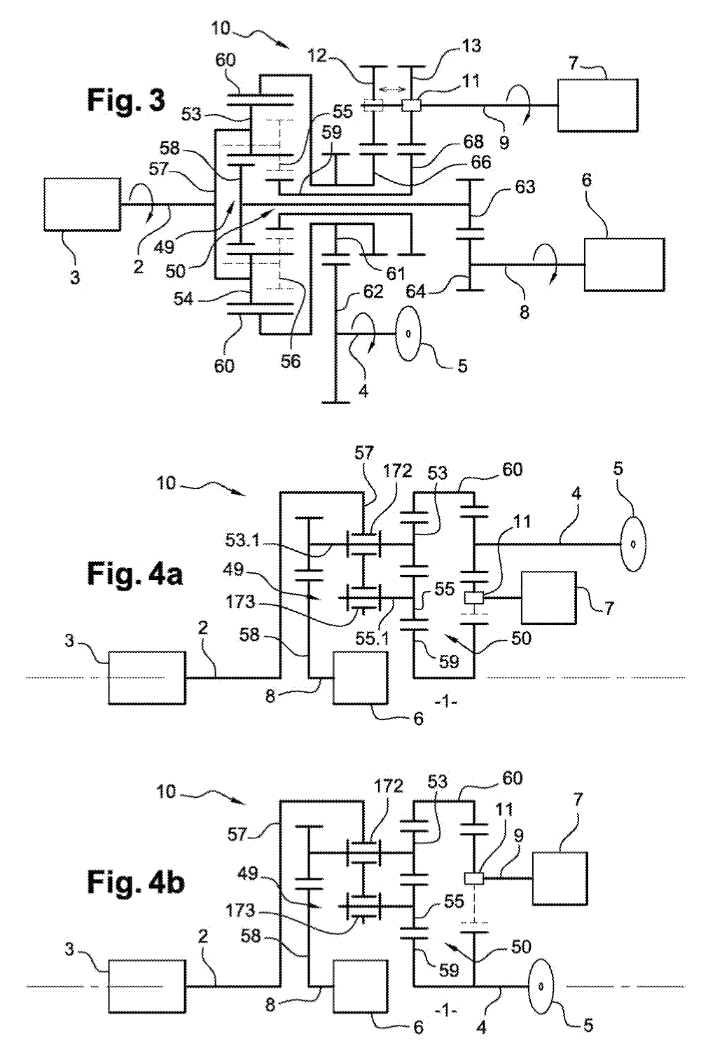

FIG. 3: A schematic representation of a transmission device according to the invention;

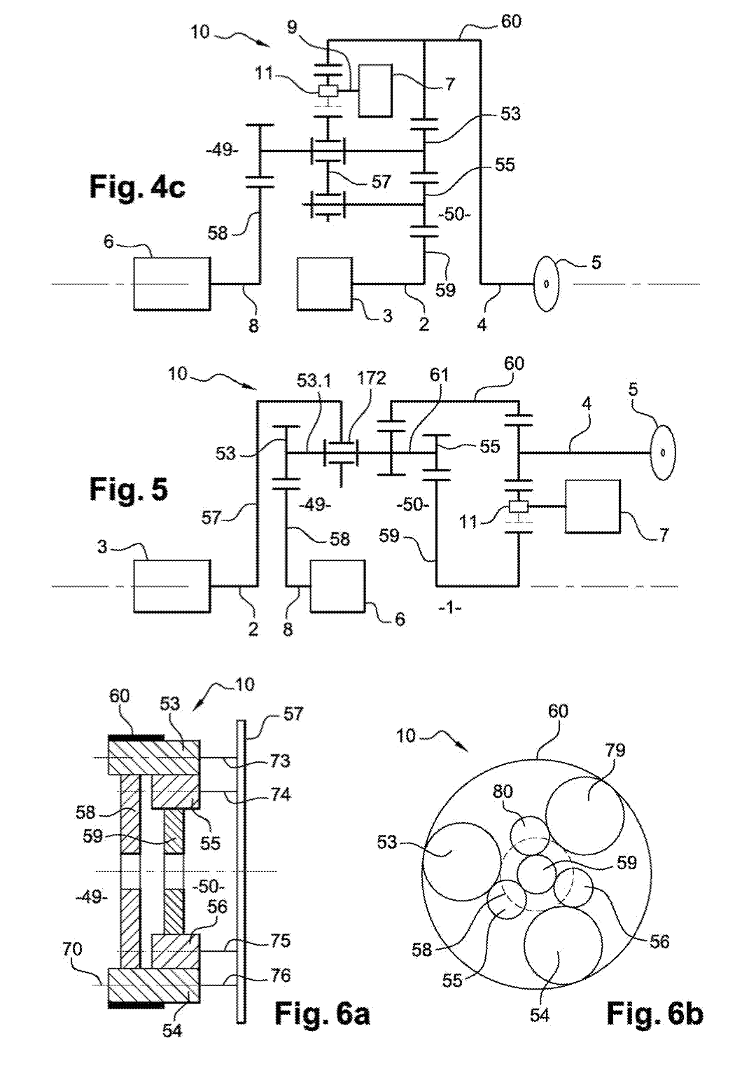

FIGS. 4a-4c: Kinematic diagrams of a transmission device according to the invention, wherein the planet gears of the gear trains intermesh;

FIG. 5: A kinematic diagram of a transmission device according to the invention in which the planets of the gear train are stepped;

FIGS. 6a-6b: Side and top views of a mechanical assembly according to the invention, having intermeshing planet gears;

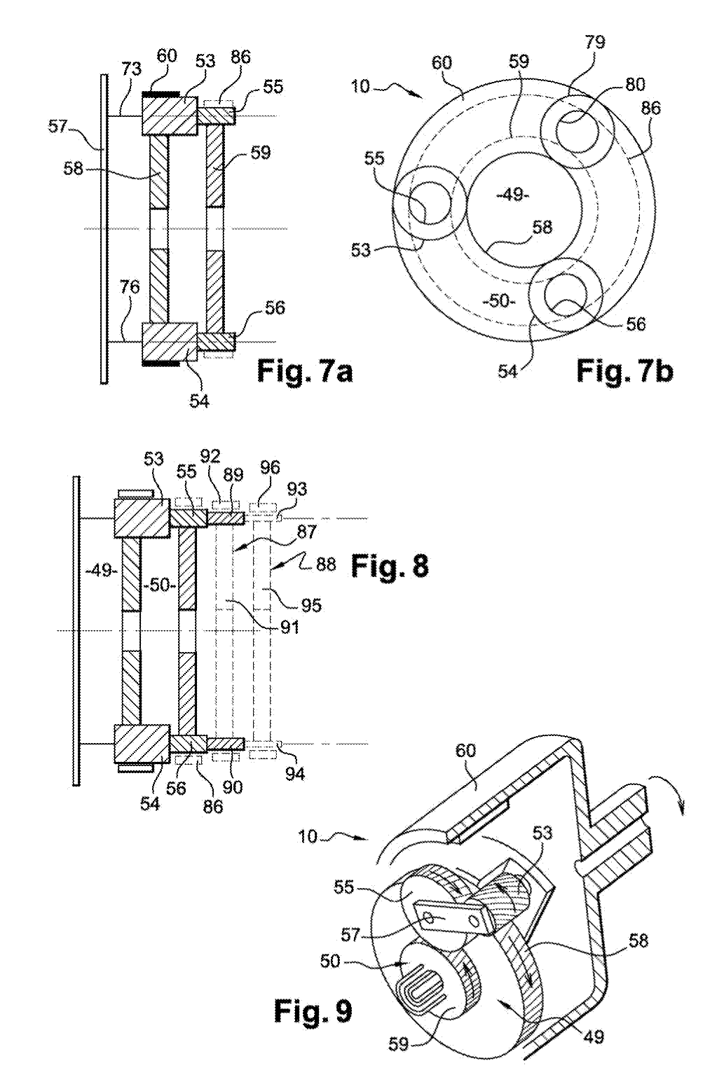

FIGS. 7a-7b: Side and top views of a mechanical assembly according to the invention, having stepped planet gears;

FIG. 8: A side view of a mechanical assembly according to the invention, having N gear trains with stepped planet gears.

FIG. 9: A three-dimensional view of a mechanical assembly according to the invention, having intermeshing planet gears.

Elements appearing in more than one figure have the same reference number.

FIG. 1 shows a device 1 for transmission between a shaft 2 of a heat engine 3 and a shaft 4 of wheels 5. This device 1 includes a first electric machine 6 and a second electric machine 7. The shaft 2 of the engine 3, the shaft 4 of the wheels 5, the shaft 8 of the first machine 6 and the shaft 9 of the second machine 7 are connected to one another through a mechanical assembly 10.

More precisely, the mechanical assembly 10 is embodied so as to offer four degrees of freedom, one for each shaft. Thus, the shaft 2 is linked to a first mobile element 10.1. The shaft 8 of the first machine 6 is linked to a second mobile element 10.2. The shaft 4 of wheels 5 is linked to a third mobile element 10.3. The shaft 9 of the second machine 7 is connectable either to the third mobile element 10.3 directly coupled to the shaft 4 of wheels 5, or to a fourth mobile element 10.4.

The shaft 9 of the second machine 7 is connected to the third mobile element 10.3 in a first operating mode of the device 1. This first mode is used for low speed ratios corresponding to speeds between 0 and 15 km/h, for a heat engine speed of 1000 rpm. This first operating mode is used especially when starting the vehicle. This first operating mode is also used for the reverse gears of the vehicle.

The shaft 9 of the second machine 7 is connected to the fourth mobile element 10.4 in a second operating mode of the device 1. This second operating mode is used for high speed ratios corresponding to vehicle speeds greater than 15 km/h, for a heat engine speed of 1000 rpm.

The coupling of the shaft 9 of the second machine 7 to the third mobile element 10.3 or to the fourth mobile element 10.4 is achieved in particular via a switch element 11 and two gear assemblies 12 and 13. This switch element 11 generally takes the form of a jaw clutch that dissipates practically no energy.

The first and second electric machines 6 and 7 are interconnected through an electrical system 14. This electrical system 14 includes in particular a first inverter 15, a second inverter 16, and an electrical bus 17 having two connections 17.1 and 17.2. In practice, this electrical bus 17 is a direct current bus. Phases 18-20 of the first machine 6 are linked to the first inverter 15, which is linked to the two connections 17.1 and 17.2 of the bus 17 via two cable linkages 21 and 22. Phases 23-25 of the second machine 7 are linked to the second inverter 16, which is linked to the two connections 17.1 and 17.2 of the bus 17 through two cable linkages 26 and 27.

In such a transmission device 1, when one of the machines 6 or 7 is operating as a generator, the alternating voltage signals detectable between phases 18-20 are transformed by the inverter associated with this machine into a DC voltage signal detectable on the bus 17. Transistors (not shown) of this inverter are then blocked, and diodes (not shown) linking a collector and an emitter of these transistors function as a rectifier bridge.

When one of the electric machines is operating as a motor, the DC voltaget signal detectable on the bus 17 is transformed into dephased alternating voltage signals by the inverter associated with this machine. These voltage signals are applied to phases 23-25. The transistors of the inverter are then operating in commutation mode, so as to chop up the DC voltage signal and invert the voltage signal applied to its terminals.

The electric machines 6 and 7 are generally three-phase synchronous machines featuring a compact design and good output.

In a case where no storage system is connected to the bus 17, the energy generated by one of the machines is automatically consumed by the other machine. As a variant, a storage system such as a battery 28 is connected to the bus 17. In a specific battery recharge mode, the two machines 6 and 7 can operate simultaneously as a generator in order to store a maximum of energy in the battery. This phase can be used especially in town, when the vehicle is braking.

It is preferable, when switching from one mode to another, for power to be zero in the electrical system in order to limit the detectable torque on the shaft along which the jaw clutch moves. Zero power is obtained by zeroing out the rotation speed of the shaft of the electric machine 6.

FIG. 2 shows a schematic representation of a transmission device 1 embodied according to the prior art. For greater clarity in the representation, the electrical system is not shown.

In this embodiment, two planetary gear trains 33 and 34 are interconnected so as to offer four degrees of freedom, one for each shaft. Each planetary gear train has three intermeshing elements. These three elements are a sun gear, a planet carrier with planets, and a ring gear. In each gear train, the planets mesh with the ring gear and the sun gear. Due to their position in the gear train, the planets cannot be directly connected to one of the shafts of the device. As a variant, each gear train has more than three elements. In one example, each gear train has a ring gear with external teeth meshing with a fourth element. In another example, each gear train has several planet carriers.

In this embodiment, the planet carrier 35 of the first gear train 33 is linked to the planet carrier 36 of the second gear train 34. In addition, the sun gear 37 of the first gear train 33 is connected to a ring gear 38 of the second gear train 34. With these two linkages, the number of degrees of freedom of the mechanical assembly 10 can be reduced to four. Without these linkages, this assembly 10 would in fact have six—three for each gear train.

Additionally, the shaft 2 of the engine 3 is connected to the sun gear 37 of the first gear train 33. The shaft 4 of wheels 5 is connected to the planet carrier 36 of the second gear train 34 through gear wheels 39 and 40, which are intermeshing. The shaft 8 of the first electric machine 6 is connected to a ring gear 41 of the first gear train 33 via gear wheels 42 and 43, which are intermeshing.

The shaft 9 of the second electric machine 7 is connectable to the planet carrier 36 of the second gear train 34 in the first operating mode. This linkage between the shaft 9 and the planet carrier 36 is accomplished through the first gear assembly 12, which engages a wheel 45. The shaft 9 of the second electric machine 7 is also connectable to the sun gear 46 of the second gear train 34 in a second operating mode. This linkage between the shaft 9 and the sun gear 46 is accomplished through the second gear assembly 13, which engages a wheel 48.

In order to switch from one mode to another, the switching device 11 moves translationally along the shaft 9 from an initial position P1 to a second position P2. In the first position P1, the device 11 drives the rotation of the first gear assembly 12. In the second position P2, the device 11 drives the rotation of the second gear assembly 13.

Referring back to FIG. 1, the first mobile element 10.1 corresponds here to the sun gear 37 of the first gear train 33. The second mobile element 10.2 corresponds to the ring gear 41 of the first gear train 33. The third mobile element 10.3 corresponds to the planet carrier 36 of the second gear train 34. The fourth mobile element 10.4 corresponds to the sun gear 46 of the second gear train 34.

As a variant, of course, it is possible to invert the linkages between the shafts 2, 4, 8 and 9 of the transmission device 1 and the elements 36, 37, 41 and 46 to which the shafts are connectable.

FIG. 3 shows a transmission device 1 embodied according to the invention. Once again, for greater clarity of representation, the electrical system is not shown.

In this embodiment, two gear trains 49 and 50 are interconnected in a manner different from that known. Indeed, in accordance with the invention, planet gears 53 and 54 of the first gear train 49 and planet gears 55 and 56 of the second gear train are connected to one another through a shared planet carrier 57. Furthermore, the planet gears 53 and 54 of the first gear train 49 intermesh with the planet gears 55 and 56 of the second gear train 50. More precisely, the planet gear 53 of the first gear train 49 meshes with the planet gear 55 of the second gear train 50. And the planet gear 54 of the first gear train 49 meshes with the planet gear 56 of the second gear train 50.

The introduction of the shared planet carrier 57 dispenses with having to connect the planet carriers of two gear trains to one another. Moreover, since the planet gears are intermeshing, one element of the second gear train 50 can be eliminated. In this embodiment, the ring gear of the second gear train 50 has been eliminated, and that is the reason it is not shown.

The mechanical assembly 10 pictured thus has four degrees of freedom. This mechanical assembly 10 therefore has four useful mobile elements to which shafts are connectable. The shared planet carrier 57 is a first useful mobile element. The sun gear 58 of the first gear train 49 is a second useful mobile element. The sun gear 59 of the second gear train 50 is a third useful mobile element. The ring gear 60 of the first gear train 49 is a fourth useful mobile element. However, the planet gears 53-56 of the first and second gear trains 49 and 50 are not useful mobile elements.

In this embodiment, the shaft 2 of the engine 3 is connected to the shared planet carrier 57. The shaft 4 of wheels 5 is connected to the ring gear 60 of the first gear train 49 via the gear wheels 61 and 62, which are intermeshing. The shaft 8 of the first electric machine 6 is connected to the sun gear 58 of the first gear train 49 through gear wheels 63 and 64, which are intermeshing. The shaft 9 of the second electric machine 7 is connectable either to the ring gear 60 through the first gear assembly 12 and a gear wheel that mesh with one another. The shaft 9 of the second electric machine 7 is also connectable to the sun gear 59 of the second gear train 50 through the second gear assembly 13 and a wheel 68.

The shaft 9 is connected to the ring gear 60 of the first gear train 49, which is directly coupled to the shaft 4 of wheels 5 in the first operating mode. The shaft 9 of the second electric machine 7 is connected to the sun gear 59 of the second gear train 50 in the second operating mode.

As previously, in order to switch from one mode to another, the jaw clutch 11 moves along the shaft 9 to achieve the connection with either the first gear assembly 12 or the second gear assembly 13.

If the ring gear of the second gear train 50 is retained, the shaft 9 of the second electric machine 7 is connectable to three different elements: the ring gear 60 of the first gear train 49, the sun gear 60 of the second gear train 50, and the ring gear (not shown) of the second gear train 50. The transmission device 1 can then operate in three different modes. These three modes can be implemented for heavy vehicles, for example, so as to make the shifts in speed ratios smoother.

In practice, a Ravigneaux-type gear train is used, which already has intermeshing planet gears.

FIG. 4a shows another representation of the transmission device 1. This representation reveals the kinematic linkages between the different elements of the mechanical assembly 10 embodied according to the invention. For greater simplicity, since the diagram is symmetrical, only one-half of the mechanical assembly 10 is shown.

This representation clearly shows that the planet gears 53 of the first gear train 49 mesh with the planet gear 55 of the second gear train 50. In addition, there is a pivot pin 172 between the shared planet carrier 57 and the gear 53. There is a second pivot pin 173 between the shared planet carrier 57 and the planet gear 55. The axes 53.1 and 55.1 of the planet gears are parallel to one another.

The planet gear 53 of the first gear train 49 also meshes with the sun gear 58 of the first gear train 49 and the ring gear 60 of this first gear train 49. The planet gear 55 of the second gear train meshes with the sun gear of this second gear train 49.

As previously, the shaft 2 of the engine 3 is connected to the shared planet carrier 57. The shaft 4 of wheels 5 is connected to the ring gear 60 of the first gear train 49. The shaft 8 of the first electric machine 6 is connected to the sun gear 58 of the first gear train 49. The shaft 9 of the second electric machine 7 is connectable either to the ring gear 60 in a first operating mode, or to the sun gear 59 of the second gear train 50 in a second operating mode. The linkages of the shaft 9 to the ring gear 60 or to the shaft 4 are accomplished through the jaw clutch 11.

The gear wheels that engage the couplings between the shafts and the elements of the assembly 10 are not shown, for greater simplicity.

FIG. 4b shows an alternative embodiment of the transmission device 1 according to the invention. In this variant, the shaft 2 of the engine 3 is connected to the shared planet carrier 57, while the shaft 4 of wheels 5 is connected to the sun gear 59 of the second gear train 50. The shaft 8 of the first electric machine 6 is connected to the sun gear 58 of the first gear train 49. The shaft 9 of the second electric machine 7 is connectable either to the sun gear 59 of the second gear train 50 in a first operating mode, or to the ring gear 60 of the first gear train 49 in a second operating mode.

FIG. 4c shows another alternative embodiment of the transmission device 1 according to the invention. In this variant, the shaft 2 of the engine 3 is connected to the sun gear 59 of the second gear train 50, while the shaft 4 of wheels 5 is connected to the ring gear 60 of the first gear train 49. The shaft 8 of the first electric machine 6 is connected to the sun gear 58 of the first gear train 49. The shaft 9 of the second electric machine 7 is connectable either to the ring gear 60 of the first gear train 49 in a first operating mode, or to the shared planet carrier 57 in a second operating mode.

Of course, these three embodiments are given only as a guide. The shaft of the engine, the shafts of the electric machines and the shafts of the wheels can be variously connected to the four mobile elements, here being the shared planet carrier 57, the sun gears 58 and 59, and the ring gear 60.

FIG. 5 shows a kinematic diagram of a transmission device 1 according to the invention with stepped planet gears. Actually, in this embodiment, the planet gear 53 of the first gear train 49 and the planet gear 55 of the second gear train 50 are integral and coaxial. The planet gears in this case are connected by a connecting rod 61. These planet gears 53 and 55 are carried by the shared planet carrier 57. There is a pivot pin 172 between the planets 53 of the first gear train 49 and the shared planet carrier 57. This pivot pin 172 allows the planet gears 53 and 55 to rotate on their axes as they are driven by the shared planet carrier 57.

In this embodiment, the planet gear 53 of the first gear train 49 meshes with the sun gear 58 and the ring gear 60 of this first gear train. The planet gear 55 of the second gear train, which is integral with the planet gear 53, meshes with the sun gear 59 of the second gear train 50.

This embodiment is in fact equivalent to the embodiment shown in FIG. 4a, wherein the planet gears intermesh. All of the described variants of the transmission device 1 with intermeshing planet gears can also be embodied with stepped planet gears.

FIGS. 6a and 6b show side and top views, respectively, of the mechanical assembly 10 according to the invention, having two gear trains with intermeshing planet gears.

In FIG. 6a, the planet gears 53 and 54 of the first gear train 49 mesh with the planet gears 55 and 56 of the second gear train 50. Shafts 73 and 76 of planets 53 and 54 of the first gear train 49 are parallel to shafts 74 and 75 of planets 55 and 56 of the second gear train 50. It is preferable for the planet gears of the first and second gear trains 49 and 50 to be of different diameters.

The shafts 73-76 are in contact with the shared planet carrier 57 and with planet gears 53-56. More precisely, one end of these shafts 73-76 is attached to the shared planet carrier 57, while the other end is connected to a planet gear via a ball bearing. These shafts 73-76 are driven by the shared planet carrier 57.

Additionally, the shared planet carrier 57 has an axis that is coincident with that of sun gears 58 and 59. As mentioned previously, the planet gears 53 and 54 of the first gear train 49 also mesh with the sun gear 58 of this first gear train and the ring gear 60 of this first gear train 49. The sun gear 59 of the second gear train 50 meshes with the planet gears 55 and 56 of this second gear train 50.

FIG. 6b shows a top view of the mechanical assembly 10 shown in FIG. 6a. Each gear train in this figure has three planet gears. As a variant, each gear train could have one, two or more planets. It is preferable to have the planet gears spaced evenly inside the ring gear 60. The planet gears 53, 54 and 79 of the first gear train 49 and the planet gears 55, 56 and 80 of the second gear train 50 are offset from one another so that they can intermesh.

The planet gears 53, 54 and 79 of the first gear train 49 each mesh with the sun gear 58 of the first gear train 49, represented with a broken line, with the ring gear 60 of the first gear train 50, and with the planet gears 55, 56 and 80 of the second gear train 50. The sun gear 59 of the second gear train 50 meshes with the planet gears 55, 56 and 80 of this second gear train 50.

The shaft of the engine, the shaft of wheel and the shafts of the machines (not shown in the figure) are each connected to one of the elements of the assembly 10.

FIG. 7a shows a side view of the mechanical assembly 10 having stepped planetary gear trains. The planet gears of the two gear trains 49 and 50 are in fact integral. In addition, the shafts 73 and 76 of the planet gears 53 and 54 of the first gear train 49 are coincident by pairs with the shafts 74 and 75 of the planet gears 55 and 56 of the second gear train 50. It is preferable for the planet gears of the first gear train 49 and the second gear train 50 to be of different diameters. Here again, the shared planet carrier 57 drives the shafts 73 and 76 in contact with this planet carrier 57 and with the planet gears 53-56.

The planet gears 53 and 54 of the first gear train 49 are connected to the shafts 73 and 76, which are in turn attached to the shared planet carrier 57. These planet gears 53 and 54 are connected to the shafts 73 and 76 via a ball bearing, for example, so as to make these planet gears 53 and 54 rotate around these shafts 73 and 76.

The sun gear 58 of the first gear train 49, the sun gear 59 of the second gear train 50 and the shared planet carrier 57 are again coaxial in this embodiment. The sun gear 58 of the first gear train 49 meshes with the planet gears 53 and 54 of the first gear train, while the sun gear 59 of the second gear train 50 meshes with the planet gears 55 and 56 of the second gear train 50. The ring gear 60 of the first gear train meshes with the planet gears 53 and 54 of the first gear train 49.

This mechanical assembly 10 thus offers four degrees of freedom. This way, the shafts 2, 4, 8 and 9 of the transmission device 1 can each be connected to one of the sun gears 58 or 59, to the shared planet carrier 57 or to the ring gear 60.

As a variant, ring gear 86 of the second gear train 50 can be inserted. This ring gear 86 meshes with the planet gears 55 and 56 of the second gear train 50. This ring gear 86 introduces an additional degree of freedom. The assembly 10 then has five degrees of freedom. In this variant, a shaft of one of the electric machines 6 or 7 is connectable to three different mobile elements. The transmission device 1 according to the invention then has three different modes of operation. The mode selection is performed as a function of the desired speed ratio. The mode is selected in such a way that the heat engine always operates at its optimal operating point. For a given engine power, this optimal operating point corresponds to the speed at which the engine consumes the least energy, that is, the lowest engine speed possible.

FIG. 7b shows a top view of the assembly 10 in FIG. 7a. This top view shows that each of the gear trains has three planet gears. It is preferable to have the planet gears spaced evenly inside the ring gear 60. That is, two straight lines passing through the center of a planet gear and the center of the ring gear 60 form a 120° angle. The planet gears 53, 54 and 79 of the first gear train 49 and the planet gears 55, 56 and 80 of the second gear train 50 are concentric and connected to one another.

In addition, the planet gears 53, 54 and 79 of the first gear train 49 mesh with the ring gear 60 of this first gear train 49, and also with the sun gear 58 of this first gear train 60. The planet gears 55, 56 and 81 of the second gear train 50 mesh with the sun gear 59 of this second gear train 50. When the assembly 10 has five degrees of freedom, the planet gears 55, 56 and 80 of the second gear train 50 also mesh with the ring gear 86 of the second gear train 50, represented with a broken line.

FIG. 8 shows an example of an embodiment of a mechanical assembly 10 having N planetary gear trains.

When two gear trains 49 and 50 are interconnected, and when one of the gear trains has no ring gear, there are four degrees of freedom. Two degrees of freedom are reserved for the shaft of the engine and the shaft of wheels. The other two degrees of freedom are reserved for the shafts of the electric machines. These other two degrees of freedom correspond to the two operating modes of the transmission device 1 according to the invention.

If one introduces an additional ring gear 86 as mentioned above, one introduces a new mobile element to which a shaft of one of the machines is connectable. A new operating mode is thereby introduced.

If one introduces yet a third gear train 87 that includes planet gears 89 and 90 connected to the planet gears of the second gear train 50, a sun gear 91, and a ring gear 92, then two new mobile elements are introduced: the ring gear 92 and the sun gear 91. A shaft of one of the machines is connectable to one of these two new mobile elements. In this way, two new operating modes of the transmission device 1 are introduced.

If in addition to this one introduces a fourth gear train 88 that includes planet gears 93 and 94 connected to planet gears 89 and 90 of the third gear train 87, a sun gear 95 and a ring gear 96, then two new mobile elements are again introduced to which a shaft of one of the machines is connectable. Again, two new operating modes are thereby introduced.

Consequently, in the invention, with N+1 planetary gear trains, the transmission device 1 is operable in 2N+1 different operating modes.

A generalization of the invention with N+1 gear trains is illustrated here for gear trains 49, 50, 87 and 88 with stepped planet gears. However, this generalization is also valid for a mechanical assembly 10 having intermeshing planet gears. The relation between the number of possible modes and the number of interconnected gear trains remains the same for N+1 gear trains having intermeshing planet gears.

FIG. 9 shows a three-dimensional illustration of a mechanical assembly 10 according to the invention. This assembly 10 has two planetary gear trains 49 and 50 whose planet gears mesh with one another.

More precisely, the first gear train 49 includes the sun gear 58, the planet gear 53 and the ring gear 60. The second gear train 50 includes the sun gear 59 and the planet gear 55. The shafts of planet gears 53 and 55 are connected to the shared planet carrier 57. One planet gear is shown on each gear train; however, these gear trains 49 and 50 generally have more planets.

The planet gear 53 of the first gear train 49 meshes with the sun gear 58 and the ring gear 60 of this first gear train. The planet gear 55 of the second gear train 50 meshes in turn with the sun gear 59 of this second gear train 50.

Furthermore, the planet gear 53 of the first gear train 46 meshes with the planet gear 55 of the second gear train 50. These two planet gears 53 and 55 are connected to the shared planet carrier 57. This assembly 10 thus corresponds to a Ravigneaux-type gear train.

The sun gear 58 of the first gear train 49, the planet gear 55 of the second gear train 50, and the ring gear 60 of the first gear train 49 have identical directions of rotation.

1. A device for power transmission, in a vehicle, between a shaft of a heat engine and a shaft of wheels including
a first and a second electric machine and
a mechanical assembly connecting the shaft of the engine, the shaft of wheels and the shafts of the two electric machine to one another, this mechanical assembly having at least two interconnected planetary gear trains, these two planetary gear trains each having several intermeshing elements, including a ring gear, planet gears connected to a planet carrier, and a sun gear,
wherein
the two planetary gear trains share a common planet carrier that drives shafts in contact with the shared planet carrier and the planet gears.

2. The device according to claim 1, wherein
the planet gears of the different gear trains mesh with one another.

3. The device according to claim 1 wherein
the planet gears of the different gear trains are integral and coaxial.

4. The device according to claim 1, wherein
the planet gears of the different gear trains have different diameters.

5. The device according to claim 1, wherein
the mechanical assembly has a first and a second gear train, the second gear train having no ring gear.

6. The device according to claim 5, wherein
the shaft of one of the electric machines is connectable to two different mobile elements, each connection corresponding to an operating mode of the transmission device.

7. The device according to claim 1, wherein
the engine is connected to the shared planet carrier,
the shaft of wheels is connected to the ring gear of the first gear train,
the shaft of the first electric machine is connected to the sun gear of the first gear train, and
the shaft of the second electric machine is connectable either to the ring gear of the first gear train in a first operating mode, or to the sun gear of the second gear train in a second operating mode.

8. The device according to claim 1, wherein
the mechanical assembly has two gear trains.

9. The device according to claim 8, wherein
the shaft of one of the electric machines is connectable to three different mobile elements, each connection corresponding to an operating mode of the transmission device.

10. The device according to claim 1, which includes an electrical linking device connecting the two electric machines to one another.
